(19) United States
(12) Patent Application Publication
(10) Pub. No.: US 2024/0204549 A1
(43) Pub. Date: Jun. 20, 2024

(54) MULTI-MODAL CONTROL OF SYSTEMS WITH MULTIPLE ENERGY SOURCES

(71) Applicant: Meta Platforms Technologies, LLC, Menlo Park, CA (US)

(72) Inventors: Ankur Gupta, Redwood City, CA (US); Karthik Kadirvel, Cupertino, CA (US)

(21) Appl. No.: 18/069,176

(22) Filed: Dec. 20, 2022

(51) Int. Cl. H02J 7/00; G06F 1/16; G06F 1/26; H01M 10/42

(52) U.S. Cl. CPC H02J 7/007; G06F 1/163; G06F 1/263; H01M 10/425; H02J 7/00032; H02J 7/0013; H02J 7/0063; H01M 2010/4278

(57) ABSTRACT

A technique and components of a device to manage power distribution of multiple energy sources based on one or more feature(s) associated with the device. The device includes at least a first battery module associated with a first mode and a second battery module associated with a second mode. The device can receive from one or more sensor(s), sensor data indicating one or more feature(s) associated with the device. The device can determine the second mode based on the one or more feature(s), and switch to the second mode. Based on the second mode, the device can determine the second battery module to provide power to the device and cause the second battery module to distribute electric power to the device.

### FIELD OF THE INVENTION

The present disclosure generally relates to multi-modal control of a system with multiple energy sources, and specifically relates to managing power distribution of the multiple energy sources based on one or more feature(s) associated with the system.

### BACKGROUND

Recent years have seen significant advancements in hardware and software platforms for generating and providing extended reality experiences. Indeed, electronic devices for providing extended reality (e.g., virtual reality, augmented reality, mixed reality, etc.) have grown in popularity, and technological advancements have facilitated its use in a variety of applications, such as gaming, online shopping, military training, and tourism. These electronic devices may be designed to be used in various usage scenarios, which may have different power consumptions and power performance requirements. In some instances, a conventional electronic device may utilize a single battery module to provide power to all the functions of the electronic device. However, such an approach may lead to tradeoffs in power and energy. For example, a battery module design that focuses on energy density may lead to poor peak performance, which may cause the electronic device to shut down unexpectedly. However, on the other hand, a battery module design that focuses on power density may lead to low battery runtime.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 is a schematic view of an example system usable to implement example techniques for managing power distribution of multiple energy sources based on one or more feature(s) associated with the system, in accordance with one or more examples.

FIG. 2 is a perspective view of an example apparatus, implemented as an eyewear device, configured to manage power distribution of multiple energy sources based on one or more feature(s) associated with the eyewear device, in accordance with one or more examples.

FIG. 3 is a perspective view of an example apparatus, implemented as a head-mounted display (HMD), configured to manage power distribution of multiple energy sources based on one or more feature(s) associated with the HMD, in accordance with one or more examples.

FIG. 4 is a flowchart of an example process for managing power distribution of multiple energy sources based on one or more feature(s) associated with an electronic device, in accordance with one or more examples.

FIG. 5 is an example system for managing power distribution of multiple energy sources based on one or more feature(s) associated with the system, in accordance with one or more examples.

### DETAILED DESCRIPTION

Conventional electronic devices may utilize a single battery module to provide power to all the functions of the electronic device. However, such an approach may lead to tradeoffs in power and energy and reduce the overall customer experience. For example, a battery module design that focuses on energy density may lead to poor peak performance, which may cause the electronic device to shut down unexpectedly. However, on the other hand, a battery module design that focuses on power density may lead to low battery runtime. Thus, the described techniques provide functionality beyond what is provided in conventional electronic devices by managing power distribution of multiple energy sources based on one or more feature(s) associated with an electronic device.

A device configured to manage power distribution of multiple energy sources based on one or more feature(s) associated with the device is described herein. The device can include one or more sensor(s) and a plurality of battery modules. The sensor(s) can include one or more of an inertial sensor, a gyroscope sensor, a proximity sensor, a biosensor, a microphone, or a temperature sensor. The plurality of battery modules includes at least a first battery module associated with a first mode of a plurality of modes and a second battery module associated with a second mode of the plurality of modes. Examples of the plurality of modes can include, but are not limited to, a standard mode, a high-power mode, a standby mode, a low-temperature mode, a high-temperature mode, etc. In some examples, the device can receive from the sensor(s), sensor data indicating one or more feature(s) associated with the device. The device can determine the second mode of the plurality of modes associated with the device based on the feature(s), and switch to the second mode based, at least in part, on the sensor data. According to the second mode, the device can determine the second battery module of the plurality of battery modules to provide power to the device and cause the second battery module to distribute electric power to the device.

In some examples, the feature(s) can include a position associated with the device. For example, the device can receive sensor data from a biosensor indicating the device is not in contact with the skin of the user. The device can determine, based at least in part on the sensor data indicating the device is not in contact with the skin of the user, a non-contact position associated with the device. The device can further determine, based on the non-contact position, a standby mode associated with the device. Based on the standby mode, the device can determine a battery module associated with the standby mode to provide power to the device.

In some examples, the feature(s) can include an application status associated with the device. For example, the device can receive sensor data from a biosensor indicating the device is in contact with the skin of the user and receive state data indicating no running application associated with the device. The device can determine, based at least in part on the sensor data and the state data, the standby mode associated with the device. Based on the standby mode, the device can determine a battery module associated with the standby mode to provide power to the device.

In some examples, the feature(s) can include a determined load associated with the device. For example, the device can receive state data indicating running applications associated with the device. The device can determine, based on the running applications, the determined load associated with the device. The device can further compare the determined load with a pre-defined threshold load. The device can determine a high-power mode based on the determined load associated with the device being greater than or equal to the pre-defined threshold load. Based on the high-power mode, the device can determine a battery module associated with the high-power mode to provide power to the device.

In some examples, the feature(s) can include a temperature associated with the device. For example, the device can receive sensor data from a temperature sensor indicating an ambient temperature near the device. The device can compare the ambient temperature with a pre-defined high-temperature threshold. The device can further determine a high-temperature mode based on the ambient temperature being greater than or equal to the pre-defined high-temperature threshold. Based on the high-temperature mode, the device can determine a battery module associated with the high-temperature mode to provide power to the device.

As another example, the device can further compare the ambient temperature with a pre-defined low-temperature threshold. The device can further determine a low-temperature mode based on the ambient temperature being less than or equal to the pre-defined low-temperature threshold. Based on the low-temperature mode, the device can determine a battery module associated with the low-temperature mode to provide power to the device.

Accordingly, techniques such as multi-modal control of an electronic device with multiple energy sources can be employed, which can detect one or more feature(s) associated with an electronic device and manage power distribution of multiple energy sources based on the feature(s) associated with the electronic device. For example, the electronic device can store a plurality of modes that define how and under what conditions (e.g., features) a battery module of a plurality of battery modules should be used to charge the electronic device. In some examples, the electronic device can receive sensor data and/or state data associated with the electronic device and determine the feature(s) associated with the electronic device. The electronic device can further determine a mode of the plurality of modes based on the feature(s) associated with the electronic device. In some examples, the feature(s) can be applied simultaneously in various combinations. In some examples, each feature of the feature(s) can be applied separately. By managing power distribution of multiple energy sources based on the feature(s) associated with the electronic device, the techniques described herein increase the active runtimes of the electronic device and improve user experience. Examples of electronic device include, but are not limited to, a wearable device (e.g., an eyewear device, glasses, headset, helmet, earphone, ear bud, hearing aid, wristband, watch, fitness tracker, ring, etc.), mobile device (e.g., phone, tablet, etc.), controller, and/or other electronic devices.

Examples of the present disclosure can include or be implemented in conjunction with an extended reality system. Extended reality is a form of reality that has been adjusted in some manner before presentation to a user, which can include, e.g., a virtual reality (VR), an augmented reality (AR), a mixed reality (MR), a hybrid reality, or some combination and/or derivatives thereof. Extended reality content can include completely computer-generated content or computer-generated content overlaid or otherwise combined with real-world content. In some examples, the real-world content can be perceived by a user directly (e.g., through a transparent or translucent lens), while in other examples, the real-world content can be captured by one or more cameras or other sensors and then displayed via a display screen or projected on to a surface for perception by the user. The extended reality content can include video, audio, haptic feedback, or some combination thereof, and any of which can be presented in a single channel or in multiple channels (such as stereo video that produces a three-dimensional effect to the viewer). Additionally, in some examples, extended reality can also be associated with applications, products, accessories, services, or some combination thereof, that are used to, e.g., create content in an extended reality and/or are otherwise used in (e.g., to perform activities in) an extended reality environment. The extended reality system that provides the extended reality content can be implemented on various platforms, including a headset (e.g., head-mounted display (HMD) and/or near-eye display (NED)) connected to a host computer system, a standalone headset, a mobile device or electronic device or system, or any other hardware platform capable of providing extended reality content to one or more viewers.

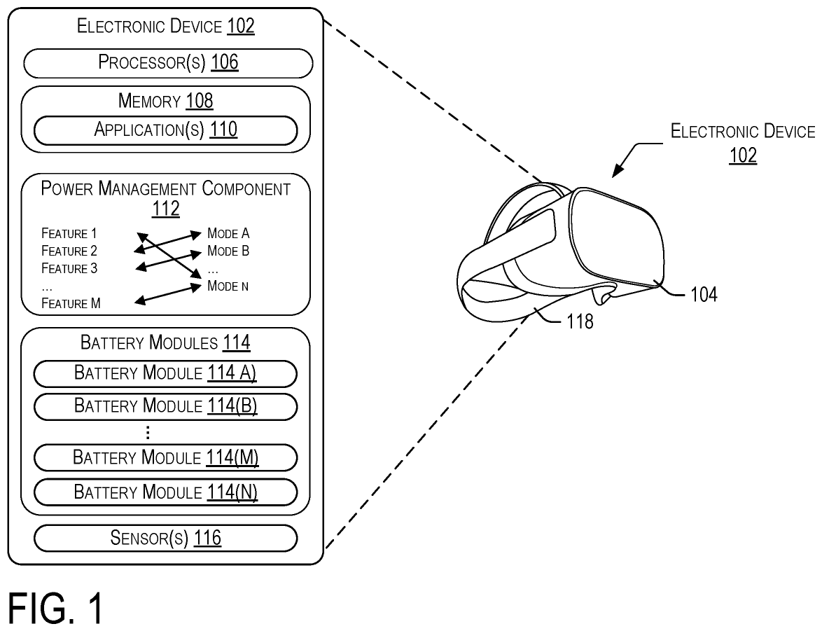

FIG. 1 is a schematic view of an example electronic device 102 configured to implement example techniques for managing power distribution of multiple energy sources based on one or more feature(s) associated with the electronic device 102. By way of example and not limitation, the electronic device 102 can include a wearable device (e.g., an eyewear device, glasses, headset, helmet, earphone, earbud, hearing aid, etc.), a mobile device (e.g., a phone, tablet, etc.), a charging case or station, a video game system or controller, and/or other portable or stationary electronic devices.

The electronic device 102 can include a depth camera assembly (DCA), one or more processor(s) 106, a memory 108 for storing one or more application(s) 110, a power management component 112, battery modules 114, one or more sensor(s) 116, and a strap 118. As illustrated in FIG. 1, the battery modules 114 can include battery modules 114(A), 114(B) . . . 114(M), 114(N) (collectively “battery modules 114”). In this example, A and N are non-zero integers greater than or equal to 1. In some examples, the strap 118, or a similar part, can contain one or more of the battery modules 114.

In some examples, the processor(s) 106 can include hardware for executing instructions, such as those making up a computer program or application. For example, to execute instructions, the processor(s) 106 can retrieve (or fetch) the instructions from an internal register, an internal cache, the memory 108, or other computer-readable media, and decode and execute them. By way of example and not limitation, the processor(s) 106 can comprise one or more central processing units (CPUs), graphics processing units (GPUs), holographic processing units, microprocessors, microcontrollers, integrated circuits, programmable gate arrays, or other hardware components usable to execute instructions.

The memory 108 is an example of computer-readable media and is communicatively coupled to the processor(s) 106 for storing data, metadata, and programs for execution by the processor(s) 106. In some examples, the memory 108 can constitute non-transitory computer-readable media such as one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 108 can include multiple instances of memory and can include internal and/or distributed memory. The memory 108 can include removable and/or non-removable storage. The memory 108 can additionally or alternatively include one or more hard disk drives (HDDs), flash memory, Universal Serial Bus (USB) drives, or a combination of these or other storage devices.

The memory 108 can store one or more application(s) 110, which can include, among other things, an operating system (OS), productivity applications (e.g., word processing applications), communication applications (e.g., email, messaging, social networking applications, etc.), games, or the like. The application(s) 110 can be implemented as one or more stand-alone applications, as one or more modules of an application, as one or more plug-ins, as one or more library functions application programming interfaces (APIs) that can be called by other applications, and/or as a cloud-computing model. The application(s) 110 can include local applications configured to be executed locally on the electronic device 102, one or more web-based applications hosted on a remote server, and/or one or more mobile device applications or “apps.”

In some examples, the power management component 112 can receive state data associated with the electronic device 102. In some examples, the state data can include power consumption data associated with the electronic device 102. In some examples, the sensor(s) 116 included in the electronic device 102 can monitor power conditions associated with the electronic device 102 in real-time or periodically. For example, a power sensor 116 included in the electronic device 102 can monitor the power consumption of the electronic device 102 in real-time. As another example, a power sensor 116 included in the electronic device 102 can monitor the power consumption associated with the electronic device 102 periodically, such as every 10 minutes, every 20 minutes, every 30 minutes, etc. In some examples, the power consumption data associated with the electronic device 102 can be determined by a power estimation module (not shown) associated with a power management component 112. For example, the power estimation module can determine power consumption associated with the electronic device 102 based on running applications associated with the electronic device 102.

In some examples, the power management component 112 can receive sensor data associated with the electronic device 102 from the sensor(s) 116. In some examples, the sensor(s) 116 can include one or more sensor(s) that generate measurement signals in response to the motion of the electronic device 102 and tracks the position (e.g., location and pose) of the electronic device 102. The sensor(s) 116 can include, for example, an optical displacement sensor, an inertial measurement unit, an accelerometer, a gyroscope, or another suitable type of sensor that detects motion. In some examples, the sensor(s) 116 can include one or more sensor(s) that are used to detect skin contact or the presence of skin near the electronic device 102. The sensor(s) 116 can include, for example, a proximity sensor, a biosensor, or another suitable type of sensor that detects detect skin contact. In some examples, the sensor(s) 116 can include one or more sensor(s) that are used to detect an ambient temperature near the electronic device 102. The sensor(s) 116 can include, for example, thermistors, resistance temperature detectors, thermocouples, semiconductor-based temperature sensors, etc. In some examples, the sensor(s) 116 can further include other types of sensors, such as power sensors, microphones, etc. Sensor data received from sensor(s) 116 can be used to determine one or more feature(s) associated with the electronic device 102.

In some examples, the power management component 112 can determine, based on the state data and/or the sensor data, one or more feature(s) associated with the electronic device 102. The power management component 112 can further determine the mode of the electronic device 102 based on the feature(s). In some examples, the feature(s) can be applied simultaneously in various combinations. In some examples, each feature of the feature(s) can be applied separately.

In some examples, the one or more feature(s) can include a position associated with the electronic device 102. For example, the power management component 112 can receive sensor data from a biosensor indicating the electronic device 102 is not in contact with the skin of a user. The power management component 112 can determine, based at least in part on the sensor data indicating the electronic device 102 is not in contact with the skin of the user, a non-contact position associated with the electronic device 102. The power management component 112 can further determine, based on the non-contact position, a standby mode associated with the electronic device 102.

In some examples, the feature(s) can include a position associated with the electronic device 102 and application status associated with the electronic device 102. For example, the power management component 112 can receive sensor data from a biosensor indicating the electronic device 102 is in contact with the skin of the user and receive state data indicating no running application associated with the electronic device 102. The power management component 112 can determine, based at least in part on the sensor data and the state data, the standby mode associated with the electronic device 102.

In some examples, the one or more feature(s) can include a determined load associated with the electronic device 102. For example, the electronic device 102 can receive state data indicating running applications associated with the electronic device 102. The power management component 112 can determine, based on the running applications, the determined load associated with the electronic device 102. The power management component 112 can further compare the determined load with a pre-defined threshold load. The power management component 112 can determine a high-power mode based on the determined load associated with the electronic device 102 being greater than or equal to the pre-defined threshold load.

In some examples, the feature(s) can include a temperature associated with the electronic device 102. For example, the power management component 112 can receive sensor data from a temperature sensor indicating an ambient temperature near the device. The power management component 112 can compare the ambient temperature with a pre-defined high-temperature threshold. The power management component 112 can further determine a high-temperature mode based on the ambient temperature being greater than or equal to the pre-defined high-temperature threshold. As another example, the power management component 112 can further compare the ambient temperature with a pre-defined low-temperature threshold. The power management component 112 can further determine a low-temperature mode based on the ambient temperature being less than or equal to the pre-defined low-temperature threshold.

In some examples, the power management component 112 can determine a second mode of a plurality of modes associated with the electronic device 102 based on the feature(s), and switch from a first mode to the second mode. Examples of modes can include, but are not limited to, a standard mode, a high-power mode, a standby mode, a low-temperature mode, or a high-temperature mode. For example, the power management component 112 can determine a low-temperature mode based on an ambient temperature associated with the electronic device 102 being less than or equal to a pre-defined low-temperature threshold and switch from a standard mode to the low-temperature mode.

In some examples, the plurality of modes can be stored in or in association with the power management component 112. The plurality of modes can define the feature(s) (e.g., system states) under which the various modes should be applied. Examples of the feature(s) can include, but are not limited to, a position associated with the electronic device 102, a determined load associated with the electronic device 102, a temperature associated with the electronic device 102, or other feature(s). The plurality of modes can be implemented in a variety of ways, including, for example, as one or more look-up tables mapping the features to modes, or as a state machine that, for a given set of features, determines an applicable mode. In some examples, each feature of the features can map to a different mode. In some examples, two or more features can map to a single mode.

In some examples, the power management component 112 can determine, based on the mode, a battery module of the plurality of battery modules 114 to provide power to the electronic device 102 and cause the battery module to distribute electric power to the electronic device 102. In some examples, the plurality of battery modules 114 can include, but are not limited to, a pouch battery module, a prismatic battery module, a coin battery module, a solid-state battery module, a capacitor battery module, an ultracapacitor battery module, a supercapacitor battery module, a micro battery module, etc.

In some examples, the plurality of battery modules 114 includes at least a first battery module associated with a first mode of a plurality of modes and a second battery module associated with a second mode of the plurality of modes. When operating in the first mode, the electronic device 102 gets its power only from the first battery module. Similarly, when operating in the second mode, the electronic device 102 gets its power only from the second battery module. In one example, the battery module 114(A) can be associated with the standby mode, and the battery module 114(B) can be associated with the high-power mode. As another example, the battery module 114(M) can be associated with the high-temperature mode, and the battery module 114(N) can be associated with the low-temperature mode.

In some examples, different types of battery cells can be used in different battery modules. For example, the battery module 114(A) associated with the standby mode can have battery cells with a higher energy density, such as lithium iron phosphate battery cells, lithium manganese oxide battery cells, or lithium nickel manganese cobalt battery cells. The battery module 114(B) associated with the high-power mode can have battery cells with a higher power output capability, such as lithium cobalt oxide battery cells. As another example, the battery module 114(M) associated with the high-temperature mode can have battery cells designed to operate at a temperature above a pre-defined high-temperature threshold, and the battery module 114(N) associated with the low-temperature mode can have battery cells designed to operate at a temperature below a pre-defined low-temperature threshold. It should be noted that, in some examples, the same type of battery cells can be used in different battery modules. For example, the higher power capability can be achieved by having certain conditions in the battery module 114(B) (e.g., higher state of charge) than in the battery module 114(A), having a lower power output capability. Alternatively, different battery modules can be formed from different types of battery cells, and power capability can depend on the type of battery cells in addition to the conditions at which cells are currently in (e.g., state of charge).

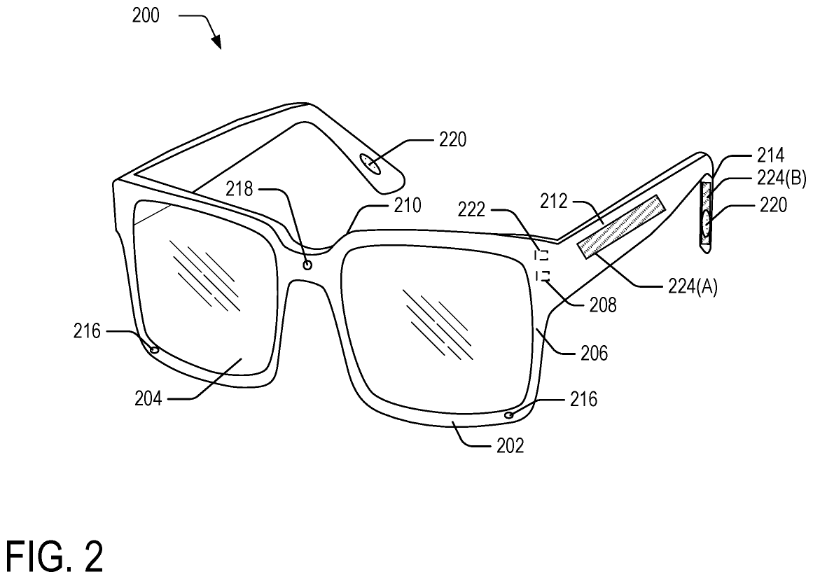

FIG. 2 is a perspective view of an example apparatus, implemented as an eyewear device, configured to manage power distribution of multiple energy sources based on one or more feature(s) associated with the eyewear device, in accordance with one or more examples.

In some examples, the eyewear device is a near-eye display (NED). In general, the headset 200 can be worn on the face of a user such that content (e.g., media content) is presented using a display assembly and/or an amplification system. Examples are also considered in which the headset 200 presents media content to a user in a different manner. Examples of media content presented by the headset 200 include one or more images, video, audio, or some combination thereof. The headset 200 includes a frame 202, and can include, among other components, a display assembly, which can include one or more display elements 204, a depth camera assembly (DCA) 206, and an amplification system 208. While FIG. 2 illustrates the components of the headset 200 in example locations on the headset 200, in some examples, the components can be located elsewhere on the headset 200, on a peripheral device paired with the headset 200, or some combination thereof. Similarly, there can be more or fewer components on the headset 200 than what is shown in FIG. 2.

The frame 202 can hold the other components of the headset 200. In some examples, the frame 202 includes a front portion 210 that holds the display element(s) 204, temples (e.g., side pieces) 212, and temple tips (e.g., end pieces) 214 to attach the headset 200 to the head of the user. In some cases, the front portion 210 of the frame 202 bridges the top of the nose of the user. In some examples, the length and/or width of the side and/or end pieces can be adjustable (e.g., adjustable temple length and/or width) to fit different users.

The display element(s) 204 can emit light visible to a user wearing the headset 200. As illustrated, the headset 200 includes a display element for each eye of a user, although other configurations of the display elements are also considered. In some examples, a display element generates image light that is provided to an eyebox of the headset 200. The eyebox can correspond to a location in space that the eye of user occupies while wearing the headset 200. For example, the display element 204 can be a waveguide display. A waveguide display includes a light source (e.g., a two-dimensional source, one or more line sources, one or more point sources, etc.) and one or more waveguides. Light from the light source is in-coupled into the one or more waveguide(s) which output the light in a manner such that there is pupil replication in an eyebox of the headset 200. In some examples, the display element(s) 204 can use one or more diffraction gratings to perform in-coupling and/or outcoupling of light from the waveguide(s). In some examples, the waveguide display includes a scanning element (e.g., waveguide, mirror, etc.) that scans light from the light source as the light is in-coupled into the waveguides. In some cases, one or both of the display element(s) 204 are opaque and do not transmit light from a local area or environment around the headset 200 through the display element(s) 204 to the eyebox. For example, the local area can be a room where a user wearing the headset 200 is inside, or the user wearing the headset 200 can be outside and the local area is an outside area. In cases in which the display element(s) 204 are opaque, the headset 200 can generate VR content to be viewed via the display element(s) 204. Examples are also considered in which one or both of the display element(s) 204 are at least partially transparent, such that light from the local area can be combined with light from the display element(s) 204 to produce AR and/or MR content.

In some examples, the display element 204 is a lens that transmits light from the local area to the eyebox. For instance, one or both of the display element(s) 204 can be a lens without correction (non-prescription) or a prescription lens (e.g., single vision, bifocal and trifocal, or progressive) to help correct for defects in a user's eyesight. In some examples, the display element 204 can be polarized and/or tinted to protect the user's eyes from the sun.

In some examples, the display element 204 can include an optics block (not shown). The optics block can include one or more optical elements (e.g., lens, Fresnel lens, etc.) that direct light from the display element 204 to the eyebox. The optics block can, in some cases, correct for aberrations in some or all of the image content, magnify some or all of the image, or some combination thereof.

The DCA 206 can determine depth information for a portion of a local area surrounding the headset 200. In some examples, the DCA 206 includes one or more imaging devices 216, a DCA controller (not shown in FIG. 2), and an illuminator 218. In some examples, the illuminator 218 illuminates a portion of the local area with light. The light can be, for instance, structured light (e.g., dot pattern, bars, etc.) in the infrared (IR), IR flash for time-of-flight, and so forth. In some examples, the imaging device(s) 216 capture images of the portion of the local area that include the light from the illuminator 218. The example headset 200 includes the single illuminator 218 and two imaging devices 216, but alternate configurations including differing numbers of illuminator(s) 218 and/or imaging device(s) 216 are also considered.

The DCA controller can compute depth information for at least a portion of the local area using captured images and one or more depth determination techniques. The DCA controller can utilize depth determination techniques such as, but not limited to, direct time-of-flight (ToF) depth sensing, indirect ToF depth sensing, structured light, passive stereo analysis, active stereo analysis (e.g., using texture added to the scene by light from the illuminator 218), other technique(s) to determine the depth of a scene, or some combination thereof. In some examples, the headset 200 can perform simultaneous localization and mapping (SLAM) for a position of the headset 200 and updating of a model of the local area. For example, the headset 200 can include a passive camera assembly (PCA) that generates color image data. The PCA can include one or more RGB cameras that capture images of some or all of the local area. In some examples, some or all of the imaging devices 206 of the DCA 206 can also function as the PCA. The images captured by the PCA and the depth information determined by the DCA 206 can be used by the headset 200 to determine parameters of the local area, generate a model of the local area, update a model of the local area, or some combination thereof.

The headset 200 can include one or more sensor(s) 220. In some examples, the sensor(s) 220 can include one or more sensor(s) that generate measurement signals in response to the motion of the headset 200 and tracks the position (e.g., location and pose) of the headset 200 within the room. For example, the sensor(s) 220 can include an optical displacement sensor, an inertial measurement unit, an accelerometer, a gyroscope, or another suitable type of sensor that detects motion, or some combination thereof. In some examples, the sensor(s) 220 can include one or more sensor(s) that are used to detect skin contact or the presence of skin near the headset 200. The sensor(s) 220 can include, for example, a proximity sensor, a biosensor, or another suitable type of sensor that detects detect skin contact. In some examples, the sensor(s) 220 can include one or more sensor(s) that are used to detect an ambient temperature near the headset 200. The sensor(s) 220 can include, for example, thermistors, resistance temperature detectors, thermocouples, semiconductor-based temperature sensors, etc. In some examples, the sensor(s) 220 can further include other types of sensors, such as power sensors, microphones, etc.

In some examples, the headset 200 includes a power management component 222. The power management component 222 can receive sensor data and/or state data indicating one or more feature(s) associated with the headset 200. Examples of state data include, but are not limited to, power condition data representing power conditions associated with the headset 200, an indication of one or more running applications associated with the headset 200, or other state data. Examples of sensor data include, but are not limited to, sensor data indicating whether or not the headset 200 is in contact with the skin of the user, sensor data indicating an ambient temperature near the headset 200, sensor data indicating a position (e.g., location and pose) associated with the headset 200, or other sensor data.

The power management component 222 can determine, based on the sensor data and/or state data, one or more feature(s) associated with the headset 200. The power management component 222 can determine, based on the feature(s), an applicable mode of a plurality of modes. The power management component 222 can further manage power distribution of one or more battery module(s) 224 based on the applicable mode. In some examples, the feature(s) can include, but are not limited to, a position associated with the headset 200, an application status associated with the headset 200, a determined load associated with the headset 200, a temperature associated with the headset 200, etc. In some examples, the plurality of modes can include, but are not limited to, a standard mode, a high-power mode, a standby mode, a low-temperature mode, a high-temperature mode, etc.

In some examples, the headset 200 includes the battery module(s) 224 to provide power to all the functions of the headset 200. As illustrated in FIG. 2, the headset 200 includes a battery module 224(A) located on the temple 222 of the headset 200, and a battery module 224(B) located on the temple tip 224 of the headset 200. In some examples, the battery module 224(A) can be associated with a first mode of the plurality of modes, and the second battery module 224(B) can be associated with a second mode of the plurality of modes. For example, the battery module 224(A) can be associated with a high-power mode and can have battery cells with a higher power output capability, and the battery module 224(B) can be associated with a standby mode and can have battery cells with a higher energy density. In some examples, the battery modules 224 can include, but are not limited to, a pouch battery module, a prismatic battery module, a coin battery module, a solid-state battery module, a capacitor battery module, an ultracapacitor battery module, a supercapacitor battery module, a micro battery module, etc.

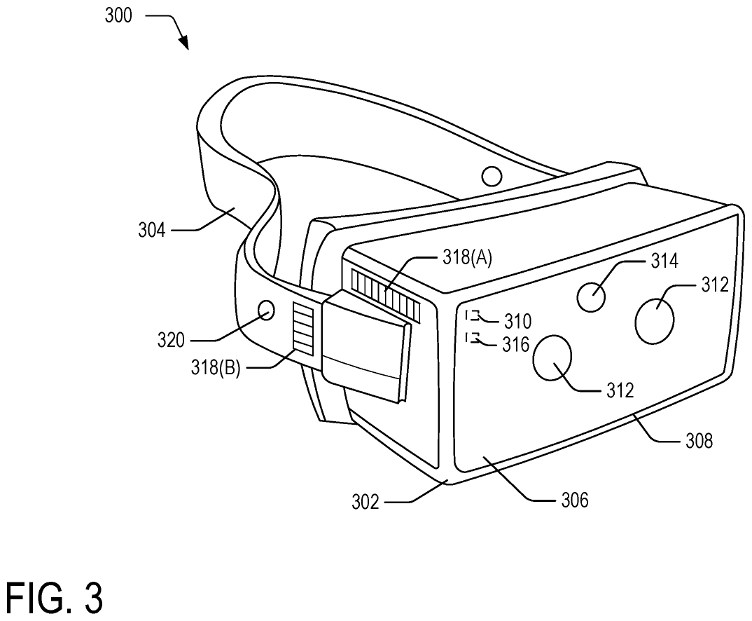

FIG. 3 is a perspective view of an example apparatus, implemented as a head-mounted display (HMD) 300, configured to manage power distribution of multiple energy sources based on one or more feature(s) associated with the HMD, in accordance with one or more examples. In some examples, portions of a front side of the HMD 300 are at least partially transparent in the visible band (e.g., ˜380 nm to 750 nm), and portions of the HMD 300 that are between the front side of the HMD 300 and an eye of the user are at least partially transparent (e.g., a partially transparent electronic display). The HMD 300 includes a front rigid body 302 and a strap or band 304. In some examples, the HMD 300 includes some or all of the same components described above with reference to FIG. 2, which may be modified to integrate with the form factor of the HMD 300. For example, the HMD 300 may include a display assembly 306, a DCA 308, and/or an amplification system 310. Additionally, in some examples, the HMD 300 includes one or more cameras or other imaging devices 312 to capture images of an environment surrounding the HMD 300, an illuminator 314 for illuminating at least a portion of the environment surrounding the HMD 300, a power management component 316, a battery module 318(A), a battery module 318(B), and one or more sensor(s) 320 (e.g., optical displacement sensors, inertial measurement units, accelerometers, gyroscopes, proximity sensors, biosensors, microphones, temperature sensors, or other sensors to detect feature(s) associated with the HMD 300). Different components may be located in various locations, such as coupled to the band 304, coupled to the front rigid body 302, or may be configured to be inserted within the ear canal of a user, to name a few examples.

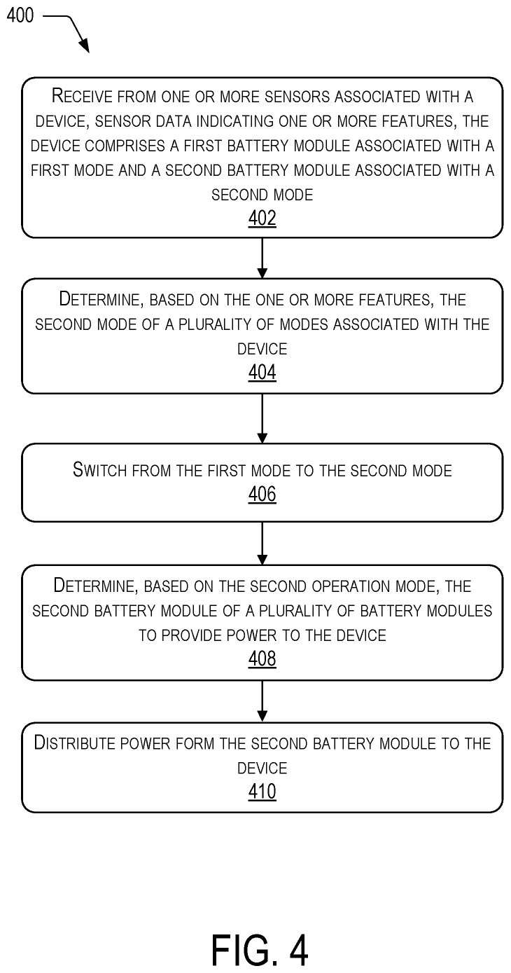

FIG. 4 is a flowchart of an example process for managing power distribution of multiple energy sources based on one or more feature(s), in accordance with one or more examples. Process 400 may be performed by components of a device (e.g., the electronic device 102, the headset 200, or the HMD 300). In some cases, the process 400 may include different and/or additional operations, and the components may perform the operations in a different order than described herein.

At operation 402, the process 400 includes receiving from one or more sensor(s) associated with a device, sensor data indicating one or more feature(s). Examples of the one or more sensor(s) can include, but are not limited to, inertial sensors, gyroscope sensors, proximity sensors, biosensors, microphones, temperature sensors, etc. Examples of the one or more feature(s) can include, but are not limited to, a position associated with the device, a determined load associated with the device, a temperature associated with the device, or other feature(s).

The device can include a plurality of battery modules. In some examples, a first battery module of the plurality of battery modules is associated with a first mode of a plurality of modes, and a second battery module of the plurality of battery modules is associated with a second mode of the plurality of modes. Examples of the plurality of modes can include, but are not limited to, a standard, a high-power mode, a standby mode, a cold temperature mode, a hot temperature mode, etc.

At operation 404, the process 400 includes determining, based on the one or more feature(s), the second mode of the plurality of modes associated with the device.

In at least one example, the device can receive sensor data from a biosensor indicating the device is not in contact with the skin of the user. The device can determine, based at least in part on the sensor data indicating the device is not in contact with the skin of the user, a non-contact position associated with the device. The device can further determine, based on the non-contact position, a standby mode associated with the device.

In at least one example, the device can receive sensor data from a biosensor indicating the device is in contact with the skin of the user and receive state data indicating no running application associated with the device. The device can determine, based at least in part on the sensor data and the state data, a standby mode associated with the device.

In at least one example, the device can receive sensor data from a temperature sensor indicating an ambient temperature near the device. The device can compare the ambient temperature with a pre-defined high-temperature threshold. The device can further determine a high-temperature mode based on the ambient temperature being greater than or equal to the pre-defined high-temperature threshold. As another example, the device can compare the ambient temperature with a pre-defined low-temperature threshold. The device can further determine a low-temperature mode based on the ambient temperature being less than or equal to the pre-defined low-temperature threshold.

At operation 406, the process 400 includes switching from the first mode to the second mode.

At operation 408, the process 400 includes determining, based on the second mode, the second battery module of the plurality of battery modules to provide power to the device. For example, the process 400 can include determining, based on a high-power mode, a battery module having battery cells with a higher power output capability to provide power to the device. As another example, the process 400 can include determining, based on a standby mode, a battery module having battery cells with a higher energy density to provide power to the device.

At operation 410, the process 400 includes distributing electric power from the second battery module to the device. Examples of the second battery module can include, but are not limited to, a pouch battery module, a prismatic battery module, a coin battery module, a solid-state battery module, a capacitor battery module, an ultracapacitor battery module, a supercapacitor battery module, a micro battery module, etc.

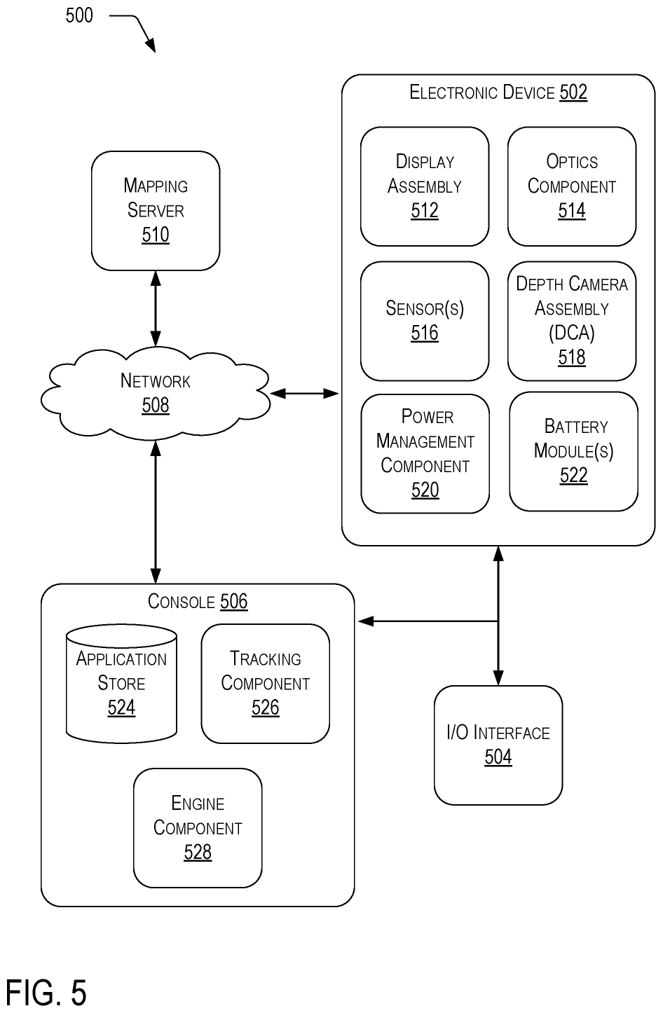

FIG. 5 is a block diagram of an example environment 500, including a system for managing power distribution of multiple energy sources based on one or more feature(s) associated with the system, in accordance with one or more examples. The example environment 500 can include an artificial reality environment (e.g., a virtual reality environment, an augmented reality environment, a mixed reality environment, or some combination thereof). The example environment 500 includes an electronic device 502, an input/output (I/O) interface 504 that is coupled to a console 506, a network 508, and a mapping server 510, although the environment may include additional and/or alternate components. In some examples, the electronic device 502 corresponds to the electronic device 102 of FIG. 1, the headset 200 of FIG. 2, the HMD 300 of FIG. 3, one or more wearable device (e.g., an eyewear device, glasses, headset, helmet, earphone, ear bud, hearing aid, wristband, watch, fitness tracker, ring, etc.), mobile device (e.g., phone, tablet, etc.), controller, and/or other electronic devices that is configured to managing power distribution of multiple energy sources based on one or more feature(s) associated with the device according to the described techniques.

While FIG. 5 shows an example environment 500 including one electronic device 502 and one I/O interface 504, examples are considered in which any number of these components can be included in the example environment 500. For example, there may be multiple electronic devices each having an associated I/O interface 504, with each electronic device and I/O interface 504 communicating with the console 506. In some cases, different and/or additional components may be included in a system in the example environment 500. Functionality described in relation to one or more of the components shown in FIG. 5 may be distributed among the components in a different manner than described herein. For example, some or all of the functionality of the console 506 may be provided by the electronic device 502.

In some examples, the electronic device 502 can include a display assembly 512, an optics component 514, one or more sensor(s) 516, a depth camera assembly (DCA) 518, a power management component 520, and one or more battery module(s) 522. Some examples of the electronic device 502 have different components than those described in relation to FIG. 5. Additionally, the functionality provided by various components described in relation to FIG. 5 may be differently distributed among the components of the electronic device 502, in some examples, or be captured in separate assemblies remote from the electronic device 502.

In some examples, the display assembly 512 displays content in accordance with data received from the console 506. The display assembly 512 can display the content using one or more display elements. A display element can be, for instance, an electronic display. In some examples, the display assembly 512 can comprise a single display element or multiple display elements (e.g., a display for each eye of a user). Examples of an electronic display include, but are not limited to, a liquid crystal display (LCD), an organic light emitting diode (OLED) display, an active-matrix organic light-emitting diode display (AMOLED), a waveguide display, or some combination of these display types. In some examples, the display assembly 512 can also be configured to perform some or all of the functionality of the optics component 514.

In some examples, the optics component 514 can magnify image light received from the display assembly 512, correct optical errors associated with the image light, and present the corrected image light to one or both eye boxes of the electronic device 502. In some examples, the optics component 514 includes one or more optical elements such as an aperture, a Fresnel lens, a convex lens, a concave lens, a filter, a reflecting surface, or any other suitable optical element that can affect image light. In some cases, the optics component 514 may include combinations of different optical elements. In some examples, one or more of the optical elements in the optics component 514 can be coated by one or more coatings, such as partially reflective or anti-reflective coatings.

Magnification and focusing of the image light by the optics component 514 allow an electronic display of the display assembly 512 to be physically smaller, weigh less, and consume less power than larger displays. Additionally, magnification by the optics component 514 can increase the field of view of the content presented by the electronic display. For example, the electronic display can display content in the field of view such that the displayed content is presented using almost all (e.g., approximately 50 degrees diagonal), and in some cases, all of a user's field of view. Additionally, in some examples, an amount of magnification can be adjusted by adding or removing optical elements of the optics component 514.

In some examples, the optics component 514 can be designed to correct one or more types of optical error. Examples of optical error include, but are not limited to, barrel or pincushion distortion, longitudinal chromatic aberrations, transverse chromatic aberrations, spherical aberrations, chromatic aberrations, or errors due to the lens field curvature, astigmatisms, and so forth. In some examples, content provided to the electronic display for display to a user can be pre-distorted, and the optics component 514 can correct the distortion after receiving the image light associated with the content.

In some examples, the sensor(s) 516 can be configured to generate data that indicates a position of the electronic device 502. In some examples, the sensor(s) 516 generates one or more measurement signals in response to motion of the electronic device 502. The sensor(s) 516 can include one or more of an IMU (Inertial Measurement Unit), accelerometer, gyroscope, magnetometer, another suitable type of sensor that detects motion, or some combination thereof. In some cases, the sensor 516 can include multiple accelerometers to measure translational motion (forward/back, up/down, left/right) and multiple gyroscopes to measure rotational motion (e.g., pitch, yaw, roll). In some examples, the sensor(s) 516 include an IMU that rapidly samples measurement signals and calculates an estimated position of the electronic device 502 from the sampled data. For example, the IMU can integrate the measurement signals received from the accelerometers over time to estimate a velocity vector and integrate the velocity vector over time to determine an estimated position of a reference point on the electronic device 502 that describes a position of the electronic device 502 in the environment. The reference point can be defined as a point in space and/or defined as a point within the electronic device 502. In some examples, the sensor(s) 516 can include one or more sensor(s) that are used to detect skin contact or the presence of skin near the electronic device 502. The sensor(s) 516 can include, for example, a proximity sensor, a biosensor, or another suitable type of sensor that detects detect skin contact. In some examples, the sensor(s) 516 can include one or more sensor(s) that are used to detect an ambient temperature near the electronic device 502. The sensor(s) 516 can include, for example, thermistors, resistance temperature detectors, thermocouples, semiconductor-based temperature sensors, etc. In some examples, the sensor(s) 516 can further include other types of sensors, such as power sensors, microphones, etc. Sensor data received from sensor(s) 516 can be used to determine one or more feature(s) associated with the electronic device 502.

In some examples, the DCA 518 generates depth information for an environment surrounding the electronic device 502. The DCA 518 can include one or more imaging devices, an illuminator, and a DCA controller (not shown).

In some examples, the power management component 520 can receive state data and/or sensor data associated with the electronic device 502 and determine one or more feature(s) associated with the electronic device 102 based on the state data and/or sensor data. Examples of the one or more feature(s) can include, but are not limited to, a position associated with the electronic device 502, a determined load associated with the electronic device 502, a temperature associated with the electronic device 502, or other feature(s).

In some examples, the power management component 520 can determine a second mode of a plurality of modes associated with the electronic device 502 based on the one or more feature(s), and switch from a first mode of the plurality of modes to the second mode. Examples of modes can include, but are not limited to, a standard mode, a high-power mode, a standby mode, a low-temperature mode, or a high-temperature mode.

In some examples, the power management component 520 can determine, based on the mode, a battery module of the battery module(s) 522 to provide power to the electronic device 502 and cause the battery module to distribute electric power to the electronic device 502. Examples of the battery module(s) 522 can include, but are not limited to, a pouch battery module, a prismatic battery module, a coin battery module, a solid-state battery module, a capacitor battery module, an ultracapacitor battery module, a supercapacitor battery module, a micro battery module, etc.

In some examples, the battery module(s) 522 includes at least a first battery module associated with the first mode of the plurality of modes and a second battery module associated with the second mode of the plurality of modes.

For example, the first battery module can be associated with the standby mode and have battery cells with a higher energy density, and the second battery module can be associated with the high-power mode and have battery cells with a higher power output capability. As another example, the first battery module can be associated with the high-temperature mode and have battery cells designed to operate at a temperature above a pre-defined high-temperature threshold, and the second battery module can be associated with the low-temperature mode and have battery cells designed to operate at a temperature below a pre-defined low-temperature threshold.

In some examples, the I/O interface 504 can be a device that allows a user to send action requests and receive responses from the console 506. In some examples, an action request can be an instruction to start or end capture of image or video data, or an instruction to perform a particular action within an application. The I/O interface 504 can include one or more input devices, such as a keyboard, a mouse, a game controller, or any other suitable device for receiving action requests and communicating the action requests to the console 506. In some examples, an action request received by the I/O interface 504 is communicated to the console 506, which performs an action corresponding to the action request. In some examples, the I/O interface 504 includes an IMU that captures calibration data that indicates an estimated position of the I/O interface 504 relative to an initial position of the I/O interface 504. In some examples, the I/O interface 504 can provide haptic feedback to the user in accordance with instructions received from the console 506. For example, haptic feedback is provided when an action request is received, or the console 506 communicates instructions to the I/O interface 504 causing the I/O interface 504 to generate haptic feedback when the console 506 performs an action.

In some examples, the console 506 provides content to the electronic device 502 for processing in accordance with information received from one or more of the DCA 518, the electronic device 502, and/or the I/O interface 504. In the example shown in FIG. 5, the console 506 includes an application store 524, a tracking component 526 and an engine component 528. Some examples of the console 506 have additional and/or different components than those described in relation to FIG. 5. Additionally, the functions described below can be distributed among components of the console 506 in a different manner than described in relation to FIG. 5. In some examples, the functionality discussed herein with respect to the console 506 can be implemented in the electronic device 502, and/or a remote system.

In some examples, the application store 524 can store one or more applications for execution by the console 506. An application is a group of instructions, that when executed by a processor, generates content for presentation to the user. Content generated by an application can be in response to inputs received from the user via movement of the electronic device 502 and/or the I/O interface 504. Examples of applications include, but are not limited to, gaming applications, conferencing applications, video playback applications, or other suitable applications.

In some examples, the tracking component 526 tracks movements of the electronic device 502 and/or of the I/O interface 504 using information from the DCA 518, the sensor(s) 516, or some combination thereof. For example, the tracking component 526 determines a position of a reference point of the electronic device 502 in a mapping of a local area of an environment based on information from the electronic device 502. The tracking component 526 can also determine positions of an object or virtual object. Additionally, in some examples, the tracking component 526 can use data that indicates a position of the electronic device 502 from the sensor(s) 516 as well as representations of the local area from the DCA 518 to predict a future location of the electronic device 502. The tracking component 526 can provide the estimated or predicted future position of the electronic device 502 and/or the I/O interface 504 to the engine component 528.

In some examples, the engine component 528 can execute applications and receive position information, acceleration information, velocity information, predicted future positions, or some combination thereof, of the electronic device 502 from the tracking component 526. Based on the received information, the engine component 528 can determine content to provide to the electronic device 502 for presentation to the user. For example, if the received information indicates that the user has looked to the left, the engine component 528 can generate content for the electronic device 502 that mirrors the user's movement in a virtual local area or in a local area augmenting the local area with additional content. Additionally, the engine component 528 can perform an action within an application executing on the console 506 in response to an action request received from the I/O interface 504 and provide feedback to the user that the action was performed. The provided feedback can be visual or audible feedback via the electronic device 502, or haptic feedback via the I/O interface 504.

In some examples, the network 508 couples the electronic device, the console 506, and the mapping server 510. The network 508 can include any combination of local area and/or wide area networks using both wireless and/or wired communication systems. For example, the network 508 can include the Internet and/or mobile telephone networks. In some cases, the network 508 uses standard communications technologies and/or protocols. Hence, the network 508 can include links using technologies such as Ethernet, 802.5, worldwide interoperability for microwave access (WiMAX), 2G/3G/4G/5G mobile communications protocols, digital subscriber line (DSL), asynchronous transfer mode (ATM), InfiniBand, PCI (Peripheral Component Interconnect) Express Advanced Switching, and so forth. The networking protocols used on the network 508 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and so on. The data exchanged over the network 508 can be represented using technologies and/or formats including image data in binary form (e.g., Portable Network Graphics (PNG)), hypertext markup language (HTML), extensible markup language (XML), and the like. In some examples, all or some information can be encrypted using encryption technologies such as secure sockets layer (SSL), transport layer security (TLS), virtual private networks (VPNs), Internet Protocol security (IPsec), and so on.

In some examples, the mapping server 510 can include a database that stores a virtual model describing a plurality of spaces, where a location in the virtual model corresponds to a current configuration of a local area of the electronic device 502. The mapping server 510 can receive, from the electronic device 502 via the network 508, information describing at least a portion of the environment surrounding the electronic device 502 and/or location information for the environment surrounding the electronic device 502. A user can adjust privacy settings to allow or prevent the electronic device 502 from transmitting information to the mapping server 510. In some examples, the mapping server 510 determines, based on the received information and/or location information, a location in the virtual model that is associated with the local area of the environment where the electronic device 502 is located. The mapping server 510 can determine (e.g., retrieve) one or more acoustic parameters associated with the local area, based in part on the determined location in the virtual model and any acoustic parameters associated with the determined location. The mapping server 510 can transmit the location of the local area and values of acoustic parameters associated with the local area to the electronic device 502.

One or more components of the example environment 500 can contain a privacy component that stores one or more privacy settings for user data elements. The user data elements describe the user and/or the electronic device 502. For example, the user data elements can describe a physical characteristic of the user, an action performed by the user, a location of the user associated with the electronic device 502, a location of the electronic device 502, an HRTF (Head Related Transfer Function) for the user, and so forth. Privacy settings (or “access settings”) for a user data element can be stored in any suitable manner, such as, for example, in association with the user data element, in an index on an authorization server, in another suitable manner, or any suitable combination thereof.

A privacy setting for a user data element specifies how the user data element (or particular information associated with the user data element) can be accessed, stored, or otherwise used (e.g., viewed, shared, modified, copied, executed, surfaced, or identified). In some examples, the privacy settings for a user data element can specify a “blocked list” of entities that may not access certain information associated with the user data element. The privacy settings associated with the user data element may specify any suitable granularity of permitted access or denial of access. For example, some entities may have permission to see that a specific user data element exists, some entities may have permission to view the content of the specific user data element, and some entities may have permission to modify the specific user data element. The privacy settings may allow the user to allow other entities to access or store user data elements for a finite period of time.

The privacy settings may allow a user to specify one or more geographic locations from which user data elements can be accessed. Access or denial of access to the user data elements may depend on the geographic location of an entity who is attempting to access the user data elements. For example, the user may allow access to a user data element and specify that the user data element is accessible to an entity only while the user is in a particular location. If the user leaves the particular location, the user data element may no longer be accessible to the entity. As another example, the user may specify that a user data element is accessible only to entities within a threshold distance from the user, such as another user associated with an electronic device within the same local area as the user. If the user subsequently changes location, the entity with access to the user data element may lose access, while a new group of entities may gain access as they come within the threshold distance of the user.

The example environment 500 may include one or more authorization/privacy servers for enforcing privacy settings. A request from an entity for a particular user data element can identify the entity associated with the request and the user data element can be sent only to the entity if the authorization server determines that the entity is authorized to access the user data element based on the privacy settings associated with the user data element. If the requesting entity is not authorized to access the user data element, the authorization server can prevent the requested user data element from being retrieved or can prevent the requested user data element from being sent to the entity. Although this disclosure describes enforcing privacy settings in a particular manner, this disclosure contemplates enforcing privacy settings in any suitable manner.

The foregoing description has been presented for illustration; it is not intended to be exhaustive or to limit the scope of the disclosure to the precise forms disclosed. Modifications and variations are contemplated considering the above disclosure.

Some portions of this description describe the examples in terms of algorithms and symbolic representations of operations on information. These algorithmic descriptions and representations may be used by those skilled in the data processing arts to convey the substance of their work effectively to others skilled in the art. These operations, while described functionally, computationally, or logically, are understood to be implemented by computer programs or equivalent electrical circuits, microcode, or the like. The described operations and their associated components may be embodied in software, firmware, hardware, or any combinations thereof.

Any of the operations or processes described herein may be performed or implemented with one or more hardware or software modules, alone or in combination with other devices. In some examples, a software module is implemented with a computer program product comprising a computer-readable medium containing computer program code, which can be executed by a computer processor for performing any or all the operations or processes described.

Examples may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Examples may also relate to a product that is produced by a computing process described herein. Such a product may comprise information resulting from a computing process, where the information is stored on a non-transitory, tangible computer readable storage medium and may include any example of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the examples is intended to be illustrative, but not limiting, of the scope of the patent rights, which is set forth in the following claims.

What is claimed is:

1. A device comprising:
one or more processors;
one or more sensors;
a plurality of battery modules, wherein the plurality of battery modules comprises:
a first battery module, wherein the first battery module is associated with a first mode of a plurality of modes; and
a second battery module different from the first battery module, wherein the second battery module is associated with a second mode of the plurality of modes; and
one or more non-transitory computer-readable media storing instructions executable by the one or more processors, wherein the instructions, when executed, cause the device to perform operations comprising:
receiving, from the one or more sensors, sensor data indicating one or more features associated with the device;
determining, based on the one or more features, the second mode of the plurality of modes associated with the device;
switching, to the second mode;
determining, based on the second mode, the second battery module of the plurality of battery modules to provide power to the device; and
distributing power from the second battery module to the device.

2. The device of claim 1, wherein the one or more features comprise a position associated with the device.

3. The device of claim 1, wherein the one or more features comprise a determined load associated with the device.

4. The device of claim 1, wherein the one or more features comprise a temperature associated with the device.

5. The device of claim 1, wherein the one or more sensors comprise: an inertial sensor, a gyroscope sensor, a proximity sensor, a biosensor, a microphone, or a temperature sensor.

6. The device of claim 1, wherein the plurality of modes comprises at least one of: a high-power mode, a standby mode, a low-temperature mode, or a high-temperature mode.

7. The device of claim 1, wherein the device comprises: a wearable glasses device, a wearable wristband device, a wearable watch device, or a wearable headset device.

8. The device of claim 1, wherein: the device comprises a wearable glasses device, the first battery module is located at a temple of the wearable glasses device, and the second battery module is located at a temple tip of the wearable glasses device.

9. The device of claim 1, wherein the plurality of battery modules comprises a pouch battery module, a prismatic battery module, a coin battery module, a solid-state battery module, a capacitor battery module, a ultracapacitor battery module, a supercapacitor battery module, or a micro battery module.

10. A method comprising:
receiving, from one or more sensors associated with a device, sensor data indicating one or more features associated with the device, wherein the device comprises a plurality of battery modules, wherein the plurality of battery modules comprises:
a first battery module, wherein the first battery module is associated with a first mode of a plurality of mode; and
a second battery module different from the first battery module, wherein the second battery module is associated with a second mode of the plurality of modes;
determining, based on the one or more features, a second mode of the plurality of modes associated with the device;
switching, to the second mode;
determining, based on the second mode, the second battery module of the plurality of battery modules to provide power to the device; and
distributing power from the second battery module to the device.

11. The method of claim 10, wherein the one or more features comprise a position associated with the device.

12. The method of claim 10, wherein the one or more features comprise a determined load associated with the device.

13. The method of claim 10, wherein the one or more features comprise a temperature associated with the device.

14. The method of claim 10, wherein the one or more sensors comprises: an inertial sensor, a gyroscope sensor, a proximity sensor, a biosensor, a microphone, or a temperature sensor.

15. The method of claim 10, wherein the plurality of modes comprises: a high-power mode, a standby mode, a low-temperature mode, or a high-temperature mode.

16. The method of claim 10, wherein the device comprises: a wearable glasses device, a wearable wristband device, a wearable watch device, or a wearable headset device.

17. The method of claim 10, wherein: the device comprises a wearable glasses device, the first battery module is located at a temple of the wearable glasses device, and the second battery module is located at a temple tip of the wearable glasses device.

18. The method of claim 10, wherein the plurality of battery modules comprises a pouch battery module, a prismatic battery module, a coin battery module, a solid-state battery module, a capacitor battery module, a ultracapacitor battery module, a supercapacitor battery module, or a micro battery module.

19. One or more non-transitory computer-readable media storing instructions executable by one or more processors, wherein the instructions, when executed, cause the one or more processors to perform operations comprising: receiving, from one or more sensors associated with a device, sensor data indicating one or more features associated with the device, wherein the device comprises a plurality of battery modules, wherein the plurality of battery modules comprises:
a first battery module, wherein the first battery module is associated with a first mode of a plurality of mode; and
a second battery module different from the first battery module, wherein the second battery module is associated with a second mode of the plurality of modes;
determining, based on the one or more features, a second mode of the plurality of modes associated with the device;
switching, to the second mode;
determining, based on the second mode, the second battery module of the plurality of battery modules to provide power to the device; and
distributing power from the second battery module to the device.

20. The one or more non-transitory computer-readable media of claim 19, wherein the one or more features comprise a position associated with the device, a determined load associated with the device, or a temperature associated with the device, and wherein the one or more sensors comprises: an inertial sensor, a gyroscope sensor, a proximity sensor, a biosensor, a microphone, or a temperature sensor.
